(19) United States
(12) Patent Application Publication
(10) Pub. No.: US 2023/0221935 A1
(43) Pub. Date: Jul. 13, 2023

(54) BLUEPRINTS-BASED DEPLOYMENT OF MONITORING AGENTS

(71) Applicant: VMWARE, INC., Palo Alto, CA (US)

(72) Inventors: VINOTHKUMAR D, Villupuram (IN); Padmini Sampige Thirumalachar, Bangalore (IN); Akansha Srivastava, Bangalore (IN); Abhishek Singh, Bangalore (IN); Suchit Dhakate, Bangalore (IN)

(21) Appl. No.: 17/687,714

(22) Filed: Mar. 7, 2022

(30) Foreign Application Priority Data
Jan. 13, 2022 (IN) 202241002120

(51) Int. Cl. G06F 8/61; H04L 67/10

(52) U.S. Cl. CPC G06F 8/61; H04L 67/10

(57) ABSTRACT

In one example, a management node includes a processor and a memory coupled to the processor. The memory may include a blueprint-generation unit and a deployment unit. The blueprint-generation unit may generate a blueprint with specifications of hardware and an operating system to be deployed in a cloud computing infrastructure. Further, the blueprint-generation unit may append a command to the blueprint. The command may download a script from a remote collector that is associated with a monitoring platform to monitor workloads. Furthermore, the memory may include a deployment unit. The deployment unit may deploy an instance of the workload on a host computing system in the cloud computing infrastructure according to the blueprint. During the deployment of the instance of the workload, the deployment unit may execute the command to deploy a monitoring agent on the workload and configure the monitoring agent to monitor the workload.

### RELATED APPLICATION

Benefit is claimed under 35 U.S.C. 119(a)-(d) to Foreign Application Serial No. 202241002120 filed in India entitled “BLUEPRINTS-BASED DEPLOYMENT OF MONITORING AGENTS”, on Jan. 13, 2022, by VMware, Inc., which is herein incorporated in its entirety by reference for all purposes.

### TECHNICAL FIELD

The present disclosure relates to computing environments, and more particularly to methods, techniques, and systems for deploying monitoring agents on workloads based on blueprints in a cloud computing infrastructure.

### BACKGROUND

In computing environments, such as networked computing environments, cloud computing environments, virtualized environments, and the like, different applications and/or services may be executed on endpoints. An example endpoint may be a physical computer system, a workload, and the like. In an example virtualized environment, multiple physical computer systems (e.g., host computing systems) may execute different workloads such as virtual machines, containers, and the like running therein. Computer virtualization may be a technique that involves encapsulating a representation of a physical computing machine platform into a virtual machine that may be executed under the control of virtualization software running on hardware computing platforms. The hardware computing platforms may also be referred as the host computing systems or servers. A virtual machine can be a software-based abstraction of the physical computer system. Each virtual machine may be configured to execute an operating system (OS), referred to as a guest OS, and applications. A container may be a data computer node that runs on top of a host OS without the need for a hypervisor or separate OS. Further, the applications running on the endpoints may be monitored to provide performance metrics (e.g., application metrics, operating system metrics, and the like) in real time to detect and diagnose issues.

### BRIEF DESCRIPTION OF THE DRAWINGS

FIG. 1 is a block diagram of an example system, depicting a management node to deploy a workload including a monitoring agent based on a blueprint;

FIG. 2 is a block diagram of an example system, depicting a cloud management platform integrated to a monitoring platform to deploy a workload;

FIG. 3 is a flow diagram, illustrating an example computer-implemented method for deploying a workload including a monitoring agent using a blueprint;

FIG. 4 is a flow diagram, illustrating another example method for deploying a workload including a monitoring agent using a blueprint; and

FIG. 5 is a block diagram of an example management node including non-transitory computer-readable storage medium storing instructions to deploy a workload including a monitoring agent based on a blueprint.

The drawings described herein are for illustration purposes and are not intended to limit the scope of the present subject matter in any way.

### DETAILED DESCRIPTION

Examples described herein may provide an enhanced computer-based and/or network-based method, technique, and system to deploy monitoring agents on workloads to monitor health of workloads in a computing environment. Computing environment may be a physical computing environment (e.g., an on-premises enterprise computing environment or a physical data center) and/or a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers executing different computing-instances or workloads (e.g., virtual machines, containers, and the like). The workloads may execute different types of applications.

For example, an organization may setup a data center (e.g., a public cloud, a private cloud, or the like) including multiple workloads (e.g., virtual machines, containers, and the like) to house critical data and applications. Irrespective of a type of data center, operations and management of the virtual infrastructure may be inevitable. In an example, a cloud management platform such as VMware vRealize Automation (vRA) is used to setup the data center. Upon setting up the data center, performance monitoring of the data center has become increasingly important because the performance monitoring may aid in troubleshooting (e.g., to rectify abnormalities or shortcomings, if any) the computing-instances, provide better health of data centers, analyse the cost, capacity, and/or the like. For example, operations management of the data center may be performed by monitoring platforms such as VMware vRealize Operations (vROps), VMware Wavefront™, Grafana, and the like.

Some example monitoring platforms may include an agent-based approach. Agent-based performance monitoring may involve an agent to be installed into the workloads for monitoring. In such an agent-based approach, the workloads include monitoring agents (e.g., Telegraf™, collectd, Micrometer, and the like) to collect the performance metrics from the respective workloads and provide, via a network, the collected performance metrics to a remote collector. Furthermore, the remote collector may receive the performance metrics from the monitoring agents and transmit the performance metrics to the monitoring tool for metric analysis (e.g., for visualization, alert definition, determining symptom root causing, remedial suggestions, and the like).

In some examples, a monitoring agent may be installed on a workload using a graphical user interface (GUI) of the monitoring platform (e.g., vROps), suite-application programming interface (API) of the vROps, a script, and the like. The GUI and API based installation may require a user to provide credentials of the workload, using which the monitoring agent may be downloaded and installed. Further, script-based installation may involve a script to be run on the workload. Thus, GUI and API based installation pushes the monitoring agent from a server to the workload and in the script-based installation, the workload may pull the monitoring agent from the server.

As enterprises setup respective cloud infrastructure using infrastructure automation tools (i.e., the cloud management platforms), the same cloud infrastructure may have to be monitored and managed by the monitoring platforms. In such scenarios, once the cloud infrastructure is setup, an additional manual step may be involved to install the monitoring agents in the workloads. The additional step may require credentials of the workload and user permissions to install the monitoring agents. For example, in a pull model, a workload may have to download and install the monitoring agent itself. Such a pull model may involve setting up a configuration manager to install the monitoring agents on multiple workloads. Further, configuring the monitoring agent to monitor a specific application running in the workload may involve another manual step. For example, configuring the monitoring agent for application monitoring may require application specific details that was setup during installation of the application in the workload. Thus, the existing methods may involve a two-step process of provisioning the workloads followed by manual steps of installing and configuring the monitoring agents. In this example, since the steps are being sequential in nature, overall time to first byte (TTFB) may be added before the performance metrics are collected.

Also, setting up the infrastructure first and then enabling the performance monitoring may involve additional manual effort. The manual installation of the monitoring agents may hinder automation and overall scalability. To install the monitoring agents, requisite permissions and credentials need to be in place. Getting such permissions may be an additional overhead. Further, for application specific monitoring, the monitoring agent has to be specifically configured. This becomes a huge concern as the agent configuration needs to take into consideration the specific settings of the application when the application was initially installed.

Examples described herein provides a management node including a processor and a memory coupled to the processor. The memory may include a blueprint-generation unit and a deployment unit. The blueprint-generation unit may generate a blueprint with specifications of hardware, an operating system, and an application to be deployed in a cloud computing infrastructure. Further, the blueprint-generation unit may append a command to the blueprint. The command, when executed, may download a script from a remote collector that is associated with a monitoring platform to monitor workloads. The deployment unit may deploy an instance of a workload on a host computing system in the cloud computing infrastructure according to the blueprint. During the deployment of the instance of the workload, the deployment unit may execute the command to deploy a monitoring agent on the workload, configure the monitoring agent to monitor an application running on the workload, and communicate the monitored information to the remote collector.

Examples described herein provide a solution to create a virtual infrastructure with the monitoring agents installed and configured therein for performance monitoring. Thus, examples described herein may prevent manual intervention to install the monitoring agent after setting up the cloud infrastructure. Furthermore, examples described herein may bundle the two sequential activities into a single-stage process, where the blueprint facilitates the workload provisioning and monitoring agent deployment and configuration. Hence, client onboarding time can be reduced as the sequential activities of procuring the workloads and configuring the monitoring agents are converted to parallel ones. Further, the customer time to value (TTV) may be reduced as the initial workload procurement may facilitate the monitoring agent configuration, thus obviating the need of any further such monitoring agent installations and/or configurations at a later stage.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

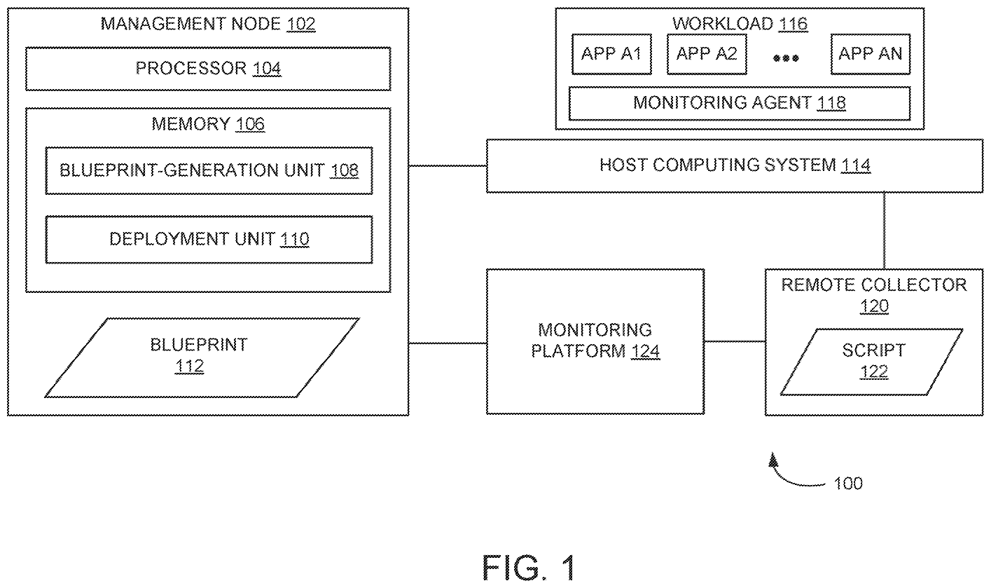

FIG. 1 is a block diagram of an example system 100, depicting a management node 102 to deploy a workload 116 including a monitoring agent 118 based on a blueprint 112. Example system 100 includes a computing environment such as a cloud computing environment (e.g., a virtualized cloud computing environment). An example cloud computing environment is VMware vSphere®. The cloud computing environment may include one or more computing platforms that support the creation, deployment, and management of virtual machine-based cloud applications. One such platform is vRealize Automation, which is commercially available from VMware. While vRealize Automation is one example of a cloud deployment platform, it should be noted that any computing platform that supports the creation and deployment of virtualized cloud applications is within the scope of the present embodiment. An application (e.g., A1-AN), also referred to as an application program, may be a computer software package that performs a specific function directly for an end user or, in some cases, for another application. Examples of applications include MySQL, Tomcat, Apache, word processors, database programs, web browsers, development tools, image editors, communication platforms, and the like.

As shown in FIG. 1, system 100 includes management node 102 and a host computing system 114, which is in communication with management node 102. For example, host computing system 114 is a physical computer. The physical computer may be a hardware-based device (e.g., a personal computer, a laptop, or the like) including an operating system (OS). Management node 102 may refer to a computing device, or computer program (i.e., executing on a computing device), that provides services to host computing system(s) 114. Management node 102 may connect to cloud deployment platforms over a network. An example network can be a managed Internet protocol (IP) network administered by a service provider. For example, the network is implemented using wireless protocols and technologies, such as WiFi, WiMax, and the like. In other examples, the network can also be a packet-switched network such as a local area network, wide area network, metropolitan area network, Internet network, or other similar type of network environment. In yet other examples, the network is a fixed wireless network, a wireless local area network (LAN), a wireless wide area network (WAN), a personal area network (PAN), a virtual private network (VPN), intranet or other suitable network system and includes equipment for receiving and transmitting signals. In the example FIG. 1, one host computing system 114 is depicted, however, the cloud computing environment can include multiple host computing systems connected to management node 102.

In some examples, in such a computing environment, clusters of host computing systems may be used to support clients for executing various applications. Further, a number of workloads (e.g., a workload 116) can be created for each client and resources (e.g., central processing unit (CPU), memory, storage, and the like) may be allocated for each workload to support application operations. In an example, workload 116 is a virtual machine. A virtual machine is an emulation of a particular computer system that operates based on a particular computer architecture, while functioning as a real or hypothetical computer. The virtual machine may operate with its own guest OS on the physical computer using resources of the physical computer virtualized by virtualization software (e.g., a hypervisor, a virtual machine monitor, and the like). In other examples, workload 116 can be a container, a software defined data centers (SDDC), or the like. The container may be a data computer node that runs on top of a host operating system without the need for the hypervisor or separate operating system. The SDDC may include various components such as a host computing system, a virtual machine, a container, or any combinations thereof.

As shown in FIG. 1, management node 102 includes a processor 104 and a memory 106 coupled to processor 104. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein.

In an example, memory 106 includes a blueprint-generation unit 108. Blueprint-generation unit 108 may generate a blueprint 112 with specifications of hardware and an OS to be deployed in a cloud computing infrastructure. In another example, blueprint 112 also includes specification of an application to be deployed in the cloud computing infrastructure. The specifications of the hardware may include a compute resource specification (e.g., processor specification, memory specification, and the like), a network resource specification (e.g., access networks, group of ports, etc.), and a storage resource specification (e.g., virtual disk specification) to deploy workload 116. In this example, storage resources may be allocated in the form of a virtual disk, which may refer to virtual machine file or virtual machine files on a file system that appear as a single hard disk to the guest OS. The virtual disk may be used to store data relating to the guest OS and applications running therein.

Further, blueprint-generation unit 108 may append a command to blueprint 112. For example, the command, when executed, downloads a script 122 from a remote collector 120 that is associated with a monitoring platform 124 to monitor workload 116.

Blueprint 112 can be mapped to corresponding ones of the clients (e.g., customers, business groups, tenants, enterprises, and the like). For example, an administrator may use an associated computing device to access management node 102 to create blueprint 112 that can be entitled to users in a specific client. For example, when a client's member requests a virtual machine, the virtual machine can be provisioned according to the specifications in blueprint 112, such as a central processing unit (CPU), memory, and storage. An example of blueprint 112 may specify a Windows 7 developer workstation with one CPU, 2 GB of memory, and a 30 GB hard disk. Further, blueprint 112 can be mapped to the client. For example, blueprint 112 can be either specific to a business group or shared among business groups in a tenant. Further, in the cloud computing infrastructure, applications can be deployed based on blueprint 112, which describe computing resources and application components to be executed on the computing resources. For example, blueprint 112 can describe one or more virtual machines and software application components to be executed on the virtual machine. Administrators (e.g., IT professionals) may manage cloud computing resources using advanced management software, such as vRealize Automation® from VMware.

Further, memory 106 includes a deployment unit 110. Deployment unit 110 may deploy an instance of workload 116 on host computing system 114 in the cloud computing infrastructure according to blueprint 112. During the deployment of the instance of workload 116, deployment unit 110 may execute the command in blueprint 112 to deploy monitoring agent 118 on workload 116. Further, deployment unit 110 may configure monitoring agent 118 to monitor workload 116. In an example, during the deployment of the instance of workload 116, deployment unit 110 may:
execute the command to download script 122 from remote collector 120, and
execute downloaded script 122 to install monitoring agent 118 on workload 116.

In an example, deployment unit 110 may configure monitoring agent 118 to communicate monitored information to monitoring platform 124 via remote collector 120. In another example, deployment unit 110 may:
retrieve, from blueprint 112, application information used to install an application in workload 116, and
configure monitoring agent 118 to monitor the application running on workload 116 using the application information in blueprint 112.

Upon configuring monitoring agent 118, monitoring agent 118 may fetch the metrics from various components of workload 116. Monitoring agent 118 may real-time monitor workload 116 to collect the metrics (e.g., telemetry data) associated with applications (e.g., APP A1 to AN) and/or an OS running in monitored workload 116. Example monitoring agent 118 includes a Telegraf agent, a Collectd agent, or the like. Metrics may include performance metric values associated with at least one of CPU, memory, storage, graphics, network traffic, or the like. Further, the fetched metrics may be provided to monitoring platform 124 via remote collector 120. In an example on-premises platform, an application remote collector (ARC) is a type of remote collector 120 that monitoring platform 124 (e.g., vROps) uses to collect metrics of applications running on workload 116 using monitoring agent 118. In an example SaaS platform, a cloud proxy is a type of remote collector 120 that monitoring platform 124 (e.g., vROps) uses to collect metrics of applications running on workload 116 using monitoring agent 118.

Further, monitoring platform 124 may display the metrics using a monitoring application (e.g., Wavefront, Grafana, New Relic, or the like) for metric analysis. Thus, examples described herein provides an approach to install the monitoring agents without requiring credential of the workload. Also, an additional component such as the configuration manager may not be involved to install the monitoring agents on the workloads.

In some examples, the functionalities described in FIG. 1, in relation to instructions to implement functions of blueprint-generation unit 108, deployment unit 110, monitoring agent 118 and any additional instructions described herein in relation to the storage medium, may be implemented as engines or modules including any combination of hardware and programming to implement the functionalities of the modules or engines described herein. The functions of blueprint-generation unit 108, deployment unit 110, and monitoring agent 118 may also be implemented by a respective processor. In examples described herein, the processor may include, for example, one processor or multiple processors included in a single device or distributed across multiple devices.

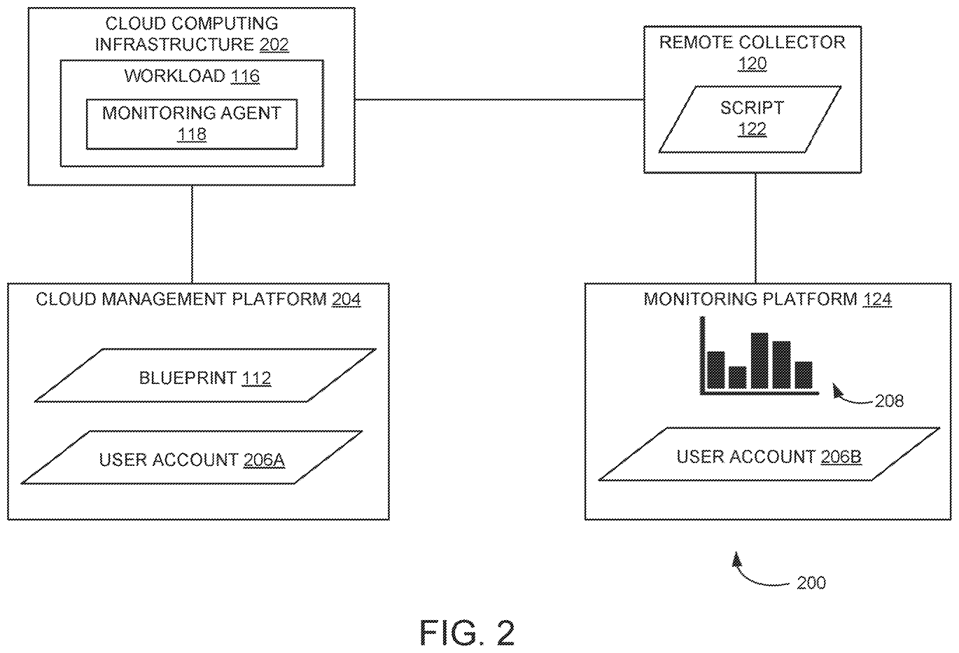

FIG. 2 is a block diagram of an example system 200, depicting a cloud management platform 204 integrated to a monitoring platform 124 to deploy a workload 116. In an example, a cloud provider provides an infrastructure automation platform or a cloud management platform 204 such as VMware vRealize Automation (vRA) to setup a cloud computing infrastructure or a data center 202. Further, operations management of cloud computing infrastructure 202 may be performed by a monitoring platform 124 such as VMware vRealize Operations (vROps). For example, monitoring platform 124 may include a monitoring application (e.g., Wavefront, Grafana, New Relic, or the like) for metric analysis via different graphs (e.g., 208 as shown in FIG. 2).

In an example, a management node (e.g., management node 102 of FIG. 1) may include a management unit to integrate cloud management platform 204 that creates and deploys workload 116 in cloud computing infrastructure 202 and monitoring platform 124 that monitors a health of workload 116 upon authentication of user accounts (e.g., user accounts 206A and 206B) associated with cloud management platform 204 and monitoring platform 124. In some examples, the management node can be implemented as a part of cloud management platform 204 or in an external platform that is connected to cloud management platform 204.

In an example, a deployment unit (e.g., deployment unit 110 of FIG. 1) obtains information of a remote collector 120 from the integration of cloud management platform 204 and the monitoring platform 124. The information may be associated with remote collector 120 managing a host computing system (e.g., host computing system 114 or cloud computing infrastructure 202) where workload 116 is to be deployed. During deployment of workload 116, deployment unit 110 may execute the command to:
establish a connection with remote collector 120 using the obtained information,
download a script 122 from remote collector 120 upon establishing the connection, and
execute script 122 to install monitoring agent 118 on workload 116.

Examples described herein is implemented using an integration of cloud management platform 204 (i.e., vRA) and monitoring platform 124 (i.e., vROps). For example, cloud management platform 204 has a feature to generate a blueprint of a workload to be deployed in cloud computing infrastructure 202. The blueprint can be used specify hardware, operating system (OS), and software to be available on deploying the workload. Further, monitoring platform 124 may monitor the health of the deployed workload 116. Further, examples described herein provides integration of cloud management platform 204 and monitoring platform 124 to perform advanced workload placement and monitoring agent deployment to provide health and workload metrics. Thus, a process of infrastructure setup is merged with the management setup. As the blueprint of the workload is going to have the application and its installation details, the monitoring agent installation and application monitoring configuration can also be done using the blueprint. On deploying that blueprint, provisioned workload includes performance monitoring agent installed, configured, and running on the workload.

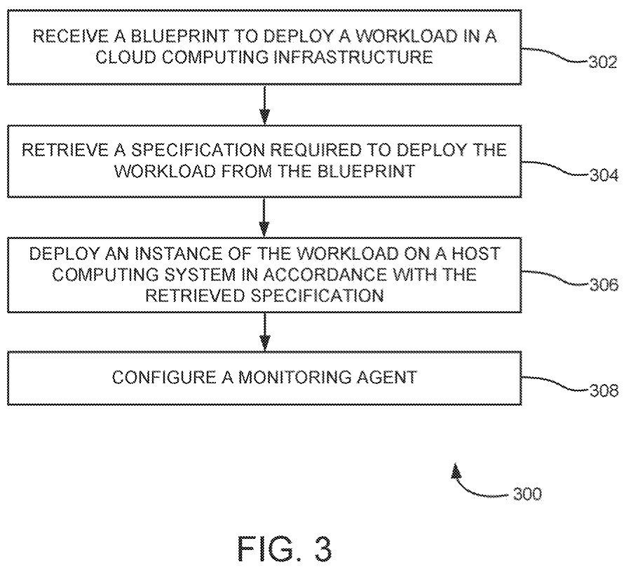

FIG. 3 is a flow diagram 300, illustrating an example computer-implemented method for deploying a workload including a monitoring agent using a blueprint. At 302, a blueprint to deploy a workload in a cloud computing infrastructure may be received. At 304, a specification required to deploy the workload may be retrieved from the blueprint. In an example, the specification includes hardware information, OS information, application information, and a command to download a script from a remote collector. The remote collector may monitor the workload and send monitored information to a monitoring platform.

At 306, an instance of the workload may be deployed on a host computing system in accordance with the retrieved specification. In an example, deploying the instance of the workload may further includes deploying a monitoring agent on the workload using the command. In an example, deploying the monitoring agent on the workload includes:
executing the command to download the script from the remote collector during deployment of the instance of the workload, and
executing the script to install the monitoring agent on the workload.

In an example, deploying the monitoring agent on the workload includes executing the script to deploy the monitoring agent on the workload during an initial boot of the workload after the instance of the workload is being deployed.

At 308, the monitoring agent may be configured to:
monitor an application running on the workload, and
communicate the monitored information to the remote collector.

In an example, configuring the monitoring agent to monitor the application running on the workload includes:
retrieving, from the blueprint, the application information used to install the application on the workload, and
configuring the monitoring agent to monitor the application running on the workload using the retrieved application information. For example, configuring the monitoring agent includes appending configuration data to a configuration file of the monitoring agent based on the retrieved application information. The configuration data may specify a configuration for the monitoring agent installed on the workload to monitor the application.

Further, method 300 may include integrating a cloud management platform that creates and deploys the workload in the cloud computing infrastructure and the monitoring platform that monitors a health of the workload using a first user account and a second user account associated with the cloud management platform and the monitoring platform, respectively. Further, the instance of the workload including the monitoring agent may be deployed based on the integration of the cloud management platform and the monitoring platform. In an example, deploying the monitoring agent on the workload includes:
obtaining, from the integration of the cloud management platform and the monitoring platform, information associated with the remote collector managing the host computing system where the workload is to be provisioned,
during deployment of the workload, executing the command to download the script from the remote collector using the obtained information associated with the remote collector, and
executing the script to install the monitoring agent on the workload.

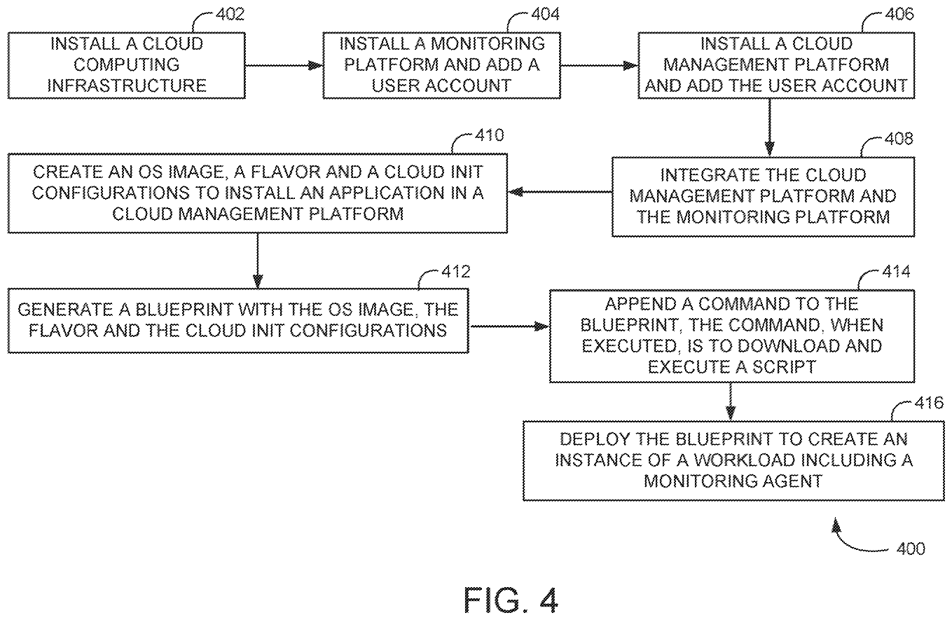

FIG. 4 is a flow diagram 400, illustrating another example method for deploying a workload including a monitoring agent using a blueprint. At 402, a cloud computing infrastructure (e.g., vCenter server) may be installed and a host computing system (e.g., ESXi) may be attached to setup a private cloud. For example, the ESXi may be a bare-metal hypervisor that installs directly onto a physical server. With direct access to and control of underlying resources, the ESXi may partition hardware to consolidate applications. Further, the vCenter server may be a server management software that provides a centralized platform for controlling cloud computing environments, allowing to automate and deliver a virtual infrastructure across a hybrid cloud. In an example, the vCenter can be installed as a virtual appliance in ESXi.

At 404, a monitoring platform (e.g., vROps) may be installed and a user account (i.e., a cloud account) corresponding to the installed cloud computing infrastructure may be added in the monitoring platform. For example, the vROps delivers intelligent operations management with application-to-storage visibility across physical, virtual, and cloud infrastructures. In an example, using policy-based automation, operations teams automate key processes and improve the IT efficiency using the vROps. Further, using data collected from system resources (e.g., components or objects), the vROps may identify issues in a monitored system component. The vROps also suggests corrective actions to fix the identified issues. Further, the vROps may offer analytical tools to review and manipulate object data to reveal hidden issues, investigate technical problems, identify trends, or drill down to gauge the health of the monitored component. In an example, to manage vCenter server instances in the vROps, the user account for the vCenter server instance is configured. The user account may involve credentials that are used for communication with the vCenter server.

At 406, a cloud management platform (e.g., vRA) may be installed and the user account corresponding to the installed cloud computing infrastructure may be added in the cloud management platform. For example, the vRA allows to create and manage the private cloud without complex manual processes. Further, the vRA allows to deploy services in the private cloud. Furthermore, the user account may be configured with permissions that a vRA cloud assembly uses to collect data from data centers and to deploy cloud templates (e.g., blueprints) to the data centers.

At 408, the cloud management platform and the monitoring platform may be integrated. For example, the vRA automation can work with the vROps manager to perform workload placement, provide deployment health and virtual machine metrics, and display pricing. Further, to add the integration, a uniform resource locator (URL) of the vROps manager and credentials for the user account may be required. Furthermore, the vRA and the vROps manager may manage the same workload in the cloud computing infrastructure.

At 410, an OS image, a flavor, and a cloud-init configuration may be created to install an application. For example, a flavor mapping groups a set of target deployment sizings for a specific user account (i.e., the cloud account/region) in the vRA cloud assembly using natural language naming. The flavor mapping creates a named mapping that contains similar flavor sizings across the user account. For example, a flavor map named standard_small might contain a similar flavor sizing (such as 1 CPU, 2 GB RAM) for some or all available account/regions in your project. When you build a blueprint, you pick an available flavor that fits your needs.

Further, the OS image may include a set of predefined target OS specifications for a specific cloud account/region in vRealize Automation Cloud Assembly by using natural language naming. Cloud vendor accounts such as Microsoft Azure and Amazon Web Services use OS images to group a set of target deployment conditions together, including OS and related configuration settings. vCenter and NSX-based environments, including VMware Cloud on AWS, use a similar grouping mechanism to define a set of OS deployment conditions. When you build and eventually deploy and iterate a blueprint, you pick an available image that best fits your needs. In an example, create a flavor with hardware specifications like vCPUs, memory, and disk. Cloud-init configuration may be a set of scripts that are executed as soon as the workload is started. The scripts can be used to install applications or configure the workload as required.

At 412, a blueprint with the OS image, flavor, and cloud-init configuration for application installation may be created. At 414, a command may be appended to the blueprint. The command, when executed, may download and execute a script. For example, Further, the command is to download the script from the remote collector and execute the command during the deployment of the workload. Further, the remote collector (i.e., ARC) and the monitoring platform (i.e., vROps) credentials details may be fetched from the monitoring platform integration. Furthermore, application configuration details may be fetched from the blueprint. Based on the credentials details and the application configuration details, the script can be executed to install the monitoring agent on the workload, configure the monitoring agent, and run the monitoring agent.

At 416, the blueprint may be deployed to create an instance of the workload. The workload may be the provisioned instances of the blueprints. During the deployment of the workload, the command may be executed to install and configure the monitoring agent (i.e., Telegraf agent) to monitor applications running in the workload. So, from the time the workload is deployed, the monitoring agent may run and collect performance metrics of the applications. Thus, no additional manual step may be needed to install and configure the monitoring agent.

The processes depicted in FIGS. 3 and 4 represent generalized illustrations, and other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

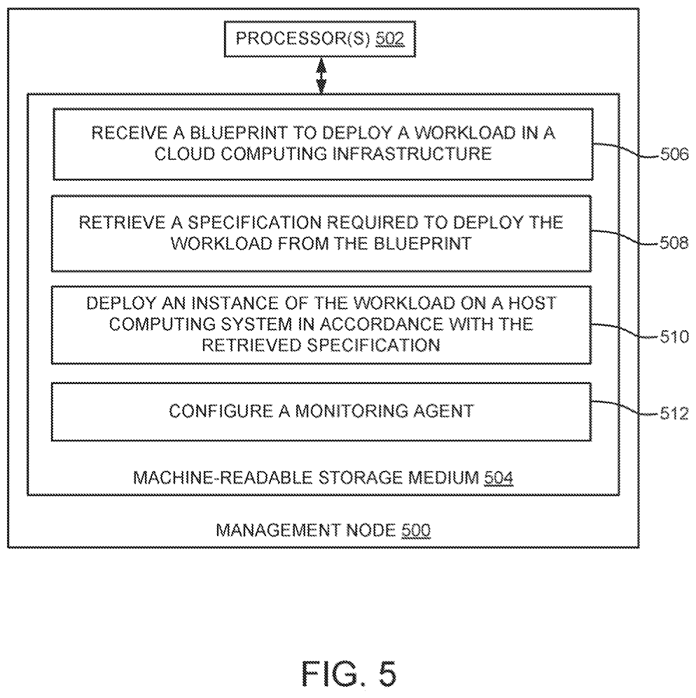

FIG. 5 is a block diagram of an example management node 500 including non-transitory computer-readable storage medium 504 storing instructions to deploy a workload including a monitoring agent based on a blueprint. Management node 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to management node 500.

Machine-readable storage medium 504 may store instructions 506, 508, 510, and 512. Instructions 506 may be executed by processor 502 to receive a blueprint to deploy a workload in a cloud computing infrastructure. Instructions 508 may be executed by processor 502 to retrieve a specification required to deploy the workload from the blueprint. In an example, the specification includes hardware information, OS information, application information, and a command to download a script from a remote collector. The remote collector may monitor the workload and send monitored information to a monitoring platform.

Instructions 510 may be executed by processor 502 to deploy an instance of the workload on a host computing system in accordance with the retrieved specification. In an example, instructions to deploy the instance of the workload further include instructions to deploy a monitoring agent on the workload using the command. For example, instructions to deploy the monitoring agent on the workload may include instructions to:
execute the command in the blueprint to download the script from the remote collector during deployment of the instance of the workload, and
execute the script to install the monitoring agent on the workload.

In an example, instructions to deploy the monitoring agent on the workload include instructions to execute the script to deploy the monitoring agent on the workload during a first boot of the workload after the workload is being deployed. Further, instructions 512 may be executed by processor 502 to configure the monitoring agent. In an example, the monitoring agent is configured to:
monitor an application running on the workload, and
communicate the monitored information to the remote collector.

In an example, instructions 512 to configure the monitoring agent to monitor the application running on the workload include instructions to:
retrieve, from the blueprint, the application information used to install the application on the workload, and
configure the monitoring agent to monitor the application running on the workload using the retrieved application information.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A management node comprising:
a processor; and
a memory coupled to the processor, the memory comprising:
a blueprint-generation unit to:
generate a blueprint with specifications of hardware and an operating system to be deployed in a cloud computing infrastructure; and
append a command to the blueprint, wherein the command is to download a script from a remote collector that is associated with a monitoring platform to monitor workloads; and
a deployment unit to:
deploy an instance of a workload on a host computing system in the cloud computing infrastructure according to the blueprint; and
during the deployment of the instance of the workload:
execute the command to deploy a monitoring agent on the workload; and
configure the monitoring agent to monitor the workload.

2. The management node of claim 1, wherein the deployment unit is to:
configure the monitoring agent to communicate monitored information to the monitoring platform via the remote collector.

3. The management node of claim 1, wherein during the deployment of the instance of the workload, the deployment unit is to:
execute the command to download the script from the remote collector; and
execute the downloaded script to install the monitoring agent on the workload.

4. The management node of claim 1, wherein the deployment unit is to:
retrieve, from the blueprint, application information used to install the application in the workload; and
configure the monitoring agent to monitor the application running on the workload using the application information in the blueprint.

5. The management node of claim 4, wherein the deployment unit is to configure the monitoring agent by:
appending configuration data to a configuration file of the monitoring agent based on the retrieved application information, the configuration data is to specify a configuration for the monitoring agent installed on the workload to monitor the application.

6. The management node of claim 1, further comprising:
a management unit to integrate a cloud management platform that creates and deploys the workload in the cloud computing infrastructure and the monitoring platform that monitors a health of the workload upon authentication of user accounts associated with the cloud management platform and the monitoring platform.

7. The management node of claim 6, wherein the deployment unit is to:
obtain, from the integration of the cloud management platform and the monitoring platform, information associated with the remote collector managing the host computing system where the workload is to be deployed; and
during deployment of the workload, execute the command to:
establish a connection with the remote collector using the obtained information;
download the script from the remote collector upon establishing the connection; and
execute the script to install the monitoring agent on the workload.

8. The management node of claim 1, wherein the specifications of the hardware comprise a compute resource specification, a network resource specification, and a storage resource specification to deploy the workload.

9. The management node of claim 1, wherein the workload is a virtual machine.

10. A computer-implemented method comprising:
receiving a blueprint to deploy a workload in a cloud computing infrastructure;
retrieving a specification required to deploy the workload from the blueprint, wherein the specification comprises hardware information, operating system information, application information, and a command to download a script from a remote collector, wherein the remote collector is to monitor workloads and send monitored information to a monitoring platform;
deploying an instance of the workload on a host computing system in accordance with the retrieved specification, wherein deploying the instance of the workload further comprises deploying a monitoring agent on the workload using the command; and
configuring the monitoring agent to:
monitor an application running on the workload; and
communicate the monitored information to the remote collector.

11. The computer-implemented method of claim 10, wherein deploying the monitoring agent on the workload comprises:
during deployment of the instance of the workload, executing the command to download the script from the remote collector; and
executing the script to install the monitoring agent on the workload.

12. The computer-implemented method of claim 10, wherein configuring the monitoring agent to monitor the application running on the workload comprises:
retrieving, from the blueprint, the application information used to install the application on the workload; and
configuring the monitoring agent to monitor the application running on the workload using the retrieved application information.

13. The computer-implemented method of claim 10, wherein deploying the monitoring agent on the workload comprises:
executing the script to deploy the monitoring agent on the workload during an initial boot of the workload after the instance of the workload is being deployed.

14. The computer-implemented method of claim 10, further comprising:
integrating a cloud management platform that creates and deploys the workload in the cloud computing infrastructure and the monitoring platform that monitors a health of the workload using a first user account and a second user account associated with the cloud management platform and the monitoring platform, respectively; and
deploying the instance of the workload including the monitoring agent based on the integration of the cloud management platform and the monitoring platform.

15. The computer-implemented method of claim 14, wherein deploying the monitoring agent on the workload comprises:
obtaining, from the integration of the cloud management platform and the monitoring platform, information associated with the remote collector managing the host computing system where the workload is to be provisioned;
during deployment of the workload, executing the command to download the script from the remote collector using the obtained information associated with the remote collector; and
executing the script to install the monitoring agent on the workload.

16. The computer-implemented method of claim 10, wherein the hardware information is to specify a compute resource, a network resource, and a storage resource to be deployed in the cloud computing infrastructure.

17. A non-transitory machine-readable storage medium comprising instructions that, when executed by a processor of a management node, cause the processor to:
receive a blueprint to deploy a workload in a cloud computing infrastructure;
retrieve a specification required to deploy the workload from the blueprint, wherein the specification comprises hardware information, operating system information, application information, and a command to download a script from a remote collector, wherein the remote collector is to monitor workloads and send monitored information to a monitoring platform;
deploy an instance of the workload on a host computing system in accordance with the retrieved specification, wherein deploying the instance of the workload further comprises deploying a monitoring agent on the workload using the command; and
configure the monitoring agent to:
monitor an application running on the workload; and
communicate the monitored information to the remote collector.

18. The non-transitory machine-readable storage medium of claim 17, wherein instructions to deploy the monitoring agent on the workload comprise instructions to:
during deployment of the instance of the workload, execute the command in the blueprint to download the script from the remote collector; and
execute the script to install the monitoring agent on the workload.

19. The non-transitory machine-readable storage medium of claim 17, wherein instructions to configure the monitoring agent to monitor the application running on the workload comprise instructions to:
retrieve, from the blueprint, the application information used to install the application on the workload; and
configure the monitoring agent to monitor the application running on the workload using the retrieved application information.

20. The non-transitory machine-readable storage medium of claim 17, wherein instructions to deploy the monitoring agent on the workload comprise instructions to:
execute the script to deploy the monitoring agent on the workload during a first boot of the workload after the workload is being deployed.
